(19) United States
(12) Patent Application Publication
(10) Pub. No.: US 2002/0104316 A1
(43) Pub. Date: Aug. 8, 2002

(54) Ultra low emissions gas turbine cycle using variable combustion primary zone airflow control

(75) Inventors: Brian Dickey, Simi Valley, CA (US); Guillermo Pont, Los Angeles, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CAPSTONE TURBINE CORPORATION, Chatsworth, CA (US)

(21) Appl. No.: 09/985,667

(22) Filed: Nov. 5, 2001

Related U.S. Application Data
(60) Provisional application No. 60/245,808, filed on Nov. 3, 2000.

(51) Int. Cl. F02C 7/00

(52) U.S. Cl. 60/772; 60/752

(57) ABSTRACT

A system and method resulting in a balanced minimization of detrimental hydrocarbon, CO and NOx emissions by regulating the air to fuel ratio in a combustor. The turbogenerator system includes a recuperator which separates air flow into a primary passage and a dilution passage. A combustor is connected to the recuperator. The cumbustor has a primary zone and a dilution zone. A controlled air valve is disposed in the air flow such that air to fuel ratio in the primary zone of the combustor is regulated at a predetermined level which minimizes the emissions.

### RELATED APPLICATIONS

This patent application claims the priority of provisional application serial No. 60/245,808, filed Nov. 3, 2000, which provisional application is incorporated by reference herein in its entirety.

### BACKGROUND OF THE INVENTION

1. Field of the Invention

The present invention relates generally to gas turbine engines. More particularly, the invention relates to gas turbines systems and methods of their use that produce very low emissions.

2. Discussion of the Background

Gas turbine engines burn fossil fuels to produce either electricity or mechanical power. However, burning of these fossil fuels creates emissions or combustion byproducts, including, nitrogen oxides (NOx), unburned hydrocarbons (THC), and carbon monoxide (CO). U.S. Pat. No. 5,457,953 discloses a design in which air headed toward a primary combustion zone is bled off and vented.

The inventor recognized novel turbogenerator systems that produce relatively low emissions and provide relatively high efficiency.

### SUMMARY OF THE INVENTION

An object of the present invention is to provide novel systems and methods for providing relatively low emission byproducts in a combustion system over a range of levels of power generation.

Another object of the invention is to provide novel structure and methods of use for actively controlling the flow of air to a primary zone of a combustor.

Yet another object of the invention is to provide novel turbogenerator systems containing the structures enabling reduceing emissions and actively controlling air flow in a combustor.

In one embodiment of the invention it comprises a novel turbogenerator system, comprising: a plenum that bifurcates into a primary passage and a dilution passage, said primary passage defines separate air flow from said dilution passage; a combustor including a primary zone and a dilution zone; an air valve disposed along said primary passage between the bifurcation in said plenum and a primary zone of said combustor such that control of said air valve can regulate air flow in said primary passage; said primary zone of said combustor coupled to said primary passage; and said dilution zone of said combustor coupled to said dilution passage.

Preferably, the turbogenerator also comprises a recuperator through which pass said primary passage and said dilution passage, a control means for controlling flux of air in said air valve to maintain an AFR value, a controller for controlling an aperture in said air valve to maintain an AFR value, and the AFR value is substantially constant over a power or fuel flow range of said turbogenerator, and the air valve is located at a compressor side of said recuperator. Preferably, the turbogenerator comprises a controller capable of adjusting said variable controlled air valve such that a quantity of air flowing through said variable controlled air valve maintains an AFR in said primary combustion zone, said controller is coupled to said air valve, there is a compressor whose exit passage defines the bifurcation in said plenum, there is a premix fuel injector coupled to an intake side of said primary zone, and said premix fuel injector capable of supplying fuel to said primary zone

The invention also comprises a novel method of using a turbogenerator system comprising the steps of: separating air flow in a plenum into a primary passage and a dilution passage, wherein said primary passage defines separate air flow from said dilution passage; controlling air flow along the primary passage from said plenum to a primary zone of a combustor with an air valve; and allowing air to flow along the dilution passage into a dilution zone of said combustor.

Preferably, the method further comprises the steps of extending said primary passage and said dilution passage through a recuperator, controlling flux of air in said air valve to maintain an AFR value, controlling an aperture in said air valve to an aperture value, the aperture value maintains an AFR value, the AFR value is substantially constant over a substantial power or fuel flow range of said turbogenerator, and the air valve is located at a compressor side of said recuperator. Preferably the method includes the additional steps of adjusting said air valve such that a quantity of air flowing through said air valve maintains an AFR in said primary combustion zone, compressing air delivered to said plenum, and heating air that passes from said plenum to said combustor using heated gases exhausted from said combustor.

The invention also comprises a novel computer program product comprising a memory medium programmed to instruct a turbogenerator to control an AFR value delivered to a primary combustion zone of a combustor of said turbogenerator. Preferably, this product comprises data stored in said medium defining at least one of (1) at least one AFR values and (2) at least one set of control values for controlling air and fuel flow that provides minimized incomplete combustion emission products when operating said turbogenerator.

The novel computer program product above may also utilize feedback signals from transducers, including emission, flameout, and or temperature sensors, to instruct a turbogenerator to control an AFR value delivered to a primary combustion zone of a combustor of a turbogenerator.

The invention also comprises a combustor portion of a generator system, comprising: a combustor including a primary zone and a dilution zone; means for providing air and fuel in an AFR to a primary zone entrance into said combustor, said primary zone entrance connecting to said primary zone; means for providing additional air to a dilution zone entrance into said combustor, and said dilution zone entrance connecting to said dilution zone.

Another novel method of the invention comprises the steps of using a turbogenerator system comprising the steps of: flowing air and fuel into a primary combustion zone of a combustor to maintain an AFR; and flowing additional air into a dilution zone of said combustor. This method preferably also has the dilution region of said combustor being closer to a turbine of said turbogenerator than said primary combustion zone, and the air flowing into both the primary combustion zone and the dilution zone being compressed air, and further comprising the step of compressing the air flowing into the primary combustion zone and the air flowing into the dilution zone in the same compressor.

Additional objects and advantages of the invention will be set forth in the following description, and in part will be evident from the description, or may be learned by practice of the invention. The objects and advantages of the invention may be realized and obtained by means of the instrumentalities and combinations particularly pointed out herein.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is perspective view, partially in section, of an integrated turbogenerator system;

FIG. 1B is a magnified perspective view, partially in section, of the motor/generator portion of the integrated turbogenerator of Fig 1A;

FIG. 1C is an end view, from the motor/generator end, of the integrated turbogenerator of FIG. 1A;

FIG. 1D is a magnified perspective view, partially in section, of the combustor-turbine exhaust portion of the integrated turbogenerator of FIG. 1A;

FIG. 1E is a magnified perspective view, partially in section, of the compressor-turbine portion of the integrated turbogenerator of FIG. 1A;

FIG. 2 is a block diagram schematic of a turbogenerator system including a power controller having decoupled rotor speed, operating temperature, and DC bus voltage control loops;

FIG. 3 is a block diagram of a low emission turbogenerator engine system including a control system capable of adjusting air flux to regions of a combustor;

FIG. 4A is a perspective view, partially in section, of the turbine of FIG. 3; and

FIG. 4B is a perspective view, of a power head casing.

### DETAILED DESCRIPTION OF THE PREFERRED EMBODIMENTS

Referring now to the drawings, like reference numerals designate identical or corresponding parts throughout the several views.

Mechanical Structural Embodiment of a Turbogenerator

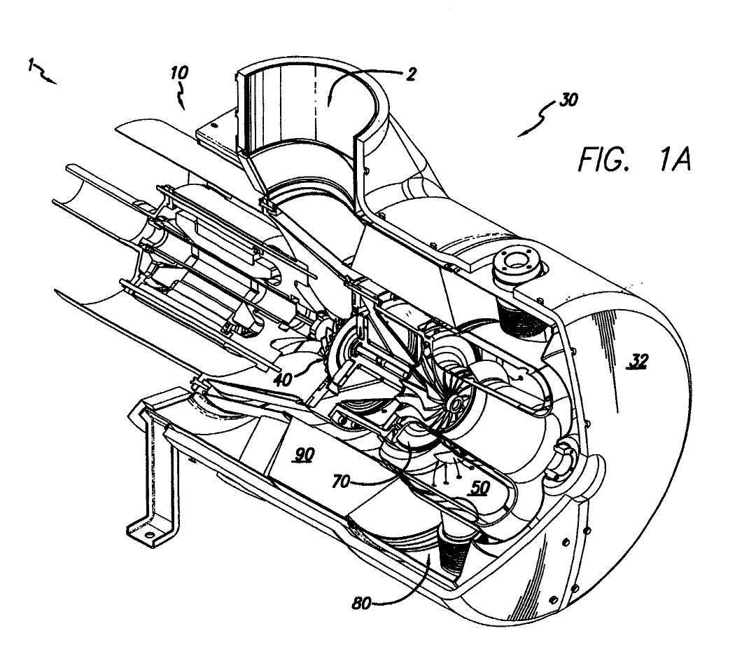

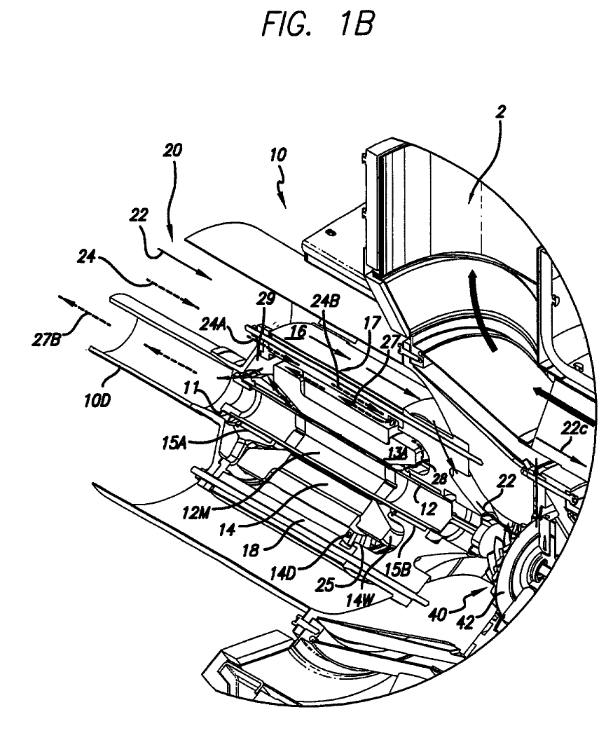

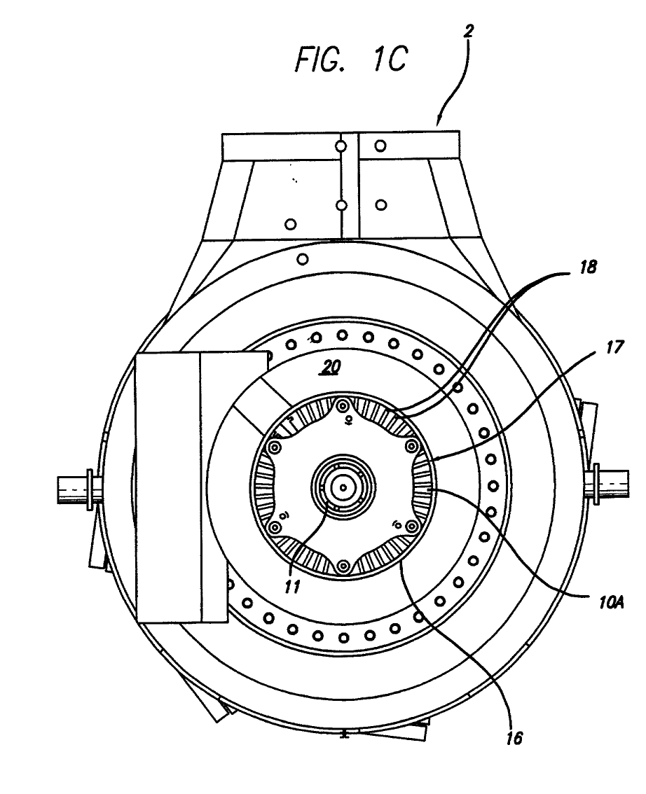

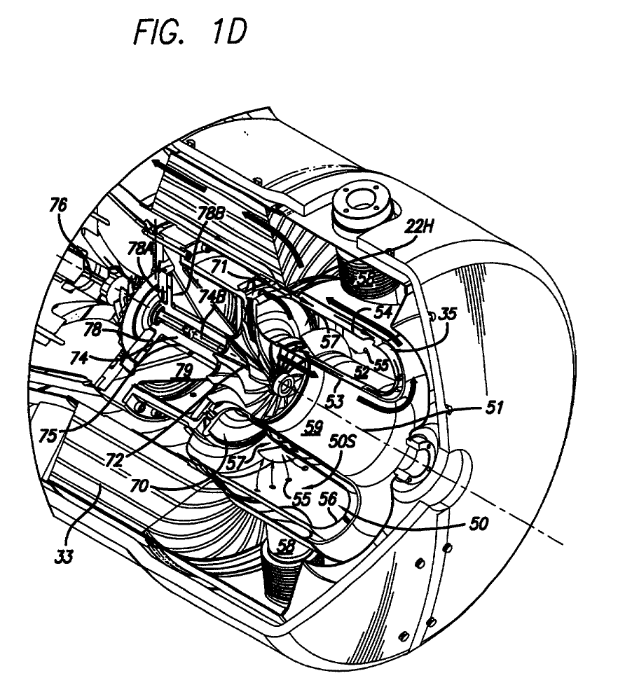

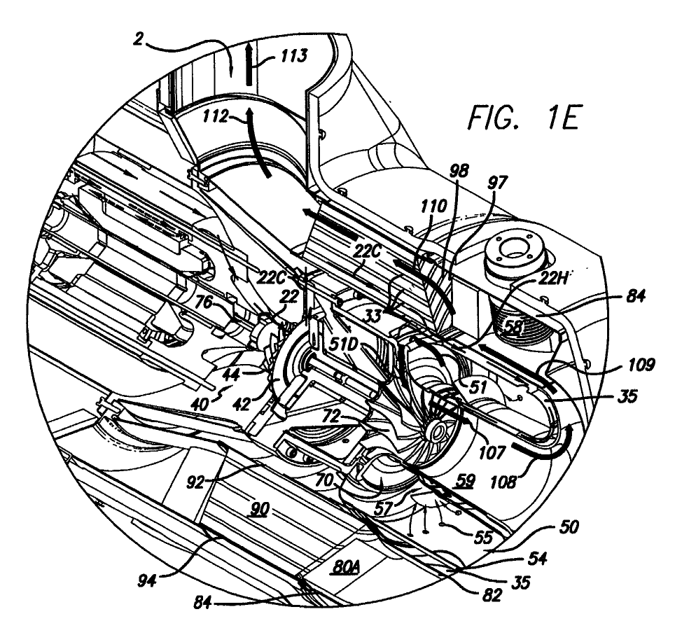

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

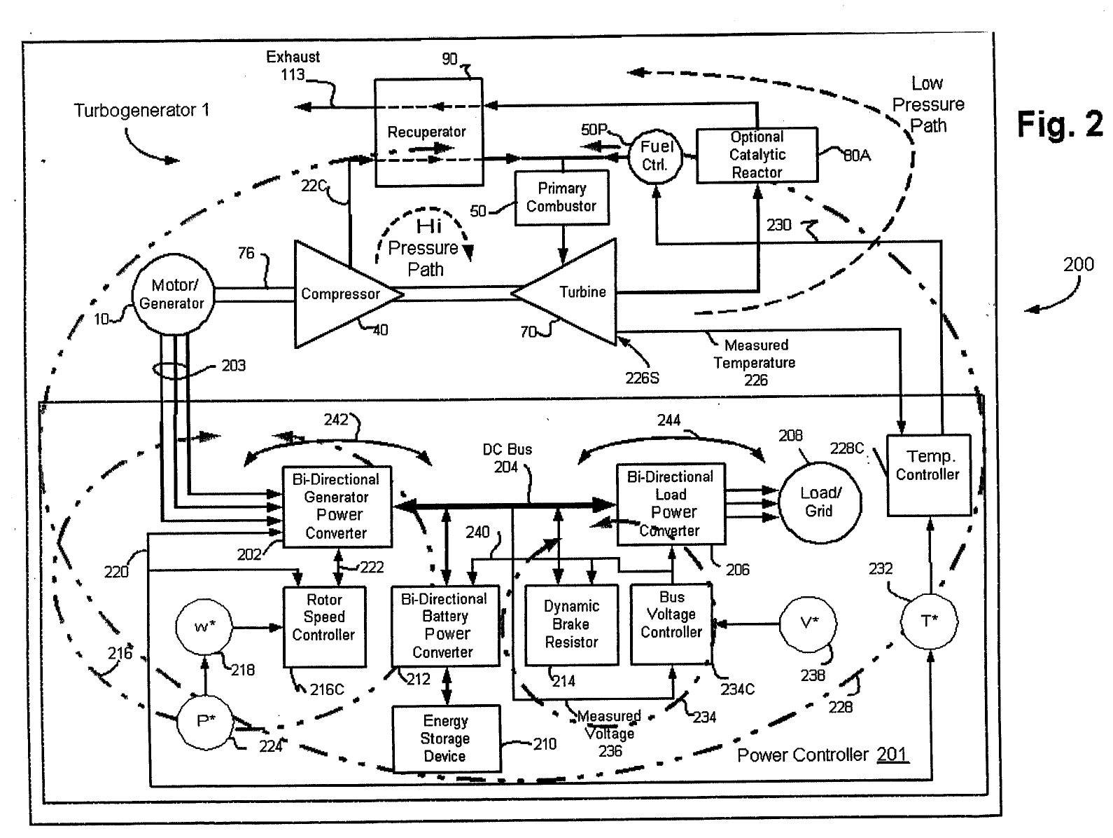

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, Bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bidirectional load power converter 206 and bidirectional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bidirectional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

The structure disclosed in FIGS. 1-2 contains elements interchangeable with elements of the structures shown in the remaining FIGS.

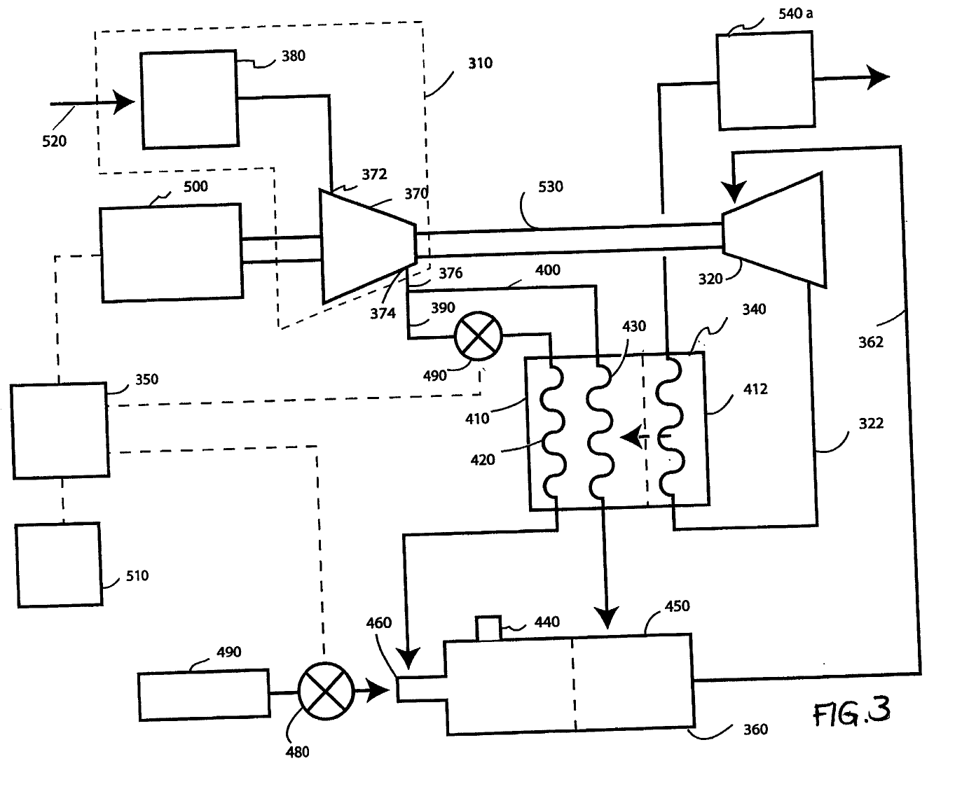

Referring now to FIG. 3, it illustrates low emissions gas turbogenerator system 300 of the present invention. Low emissions gas turbogenerator system 300 includes compressor system 310, turbine 320, recuperator 340, digital power controller 350, and combustor 360.

Compressor system 310 includes compressor 370 and air filter 380. Compressor 370 is coupled at an intake side 372 to air filter 380. Compressor 370 is coupled at an outlet side 374 to initial air channel 376. A bifurcated flow path extends from compressor 370 via initial flow channel 376 to recuperator 340. The bifurcated flow path is formed by first air channel 390 and second air channel 400.

Recuperator 340 is shown as including cold side 410 and hot side 412. The term “side” is used only for convenience in explaining the invention, since cold flow paths containing gas to be heated and hot flow paths containing air gas in recuperator 340 may not be separated on different sides of recuperator 340. Cold side 410 includes primary zone passage 420 and dilution zone passage 430. The inlet of primary zone passage 420 is coupled to first air channel 390, and the inlet of dilution zone passage 430 is coupled to second air channel 400. Primary zone passage 420 of cold side 410 of recuperator 340 is coupled to one or more intakes of combustor 360, such as one or more premix injectors 460. The intake of hot side 412 of recuperator 340 is coupled to flow path 322 extending from an outlet of turbine 330. Optionally, catalytic converter 540 may be coupled to either the exhaust side of recuperator 340 or the flow path 322.

Combustor 360 includes walls forming primary zone 440 and dilution zone 450. Primary zone 440 is coupled preferably via premix injector 460 to primary zone passage 420, and dilution zone 450 is coupled to dilution zone passage 430. Premix injector 460 is disposed at the intake of primary zone 440 such that flow from primary zone passage 420 enters premix injector 460 and then passes into primary zone 440. Flow passage 362 couples an exhaust side of combustor 360 to an intake side of turbine 320.

Air valve 470 is coupled between compressor 370 and primary zone passage 420 of recuperator 340. In the preferred embodiment, air valve 470 is disposed along first air channel 390. However, air valve 470 may be located between recuperator 340 and combustor 360. Air valve 470 is controlled by digital power controller 350 to provide a controlled flux of air. However, air valve 470 could be controlled instead by an analog controller.

Fuel valve 480 is coupled between inlet fuel 490 and premix injector 460. Fuel valve 480 is controlled by digital power controller 350 to provide a controlled flux of fuel. However, fuel valve 480 could be controlled instead by an analog controller.

Digital power controller 350 is coupled to starter or motor generator 500, air valve 470, and fuel valve 480. Digital power controller 350 may also be coupled to load 510.

During operation, inlet air (represented by arrow 520), which is typically at room pressure, is drawn through air filter 380 into compressor 370. In compressor 370, inlet air 520 is compressed to a higher pressure. The compressed air then exits compressor 370 at 374, and then bifurcates to passages 390, 400. Preferably, air channel 400 provides a relatively constant flux of air to dilution zone passage 430 and then to dilution zone 450. This occurs when pressure upstream of air valve 470 is not significantly affected by changes in flux of air traversing air valve 470. Flux of air traversing air channel 390 varies depending upon the degree to which air valve 470 is open. Air valve 470 is regulated by controller 350 and maintains the flux of air through first air channel 390 to a value intended to maintain a constant air-to-fuel ratio (AFR) in primary combustion zone 440 for a specified fuel flux.

The AFR is predetermined to be at a value that minimize emissions produced during combustion at a power generation level, and different AFRs may be predetermined for a range of power levels. The AFR fuel ratio that results in a balanced minimization of detrimental hydrocarbon, CO and NOx emissions depends of course upon geometric properties of the combustor, but can easily be determined by measuring emissions at a given fuel flux as a function of air flux. Although AFR ratios depend upon many factors, typical primary zone AFRs that provide minimal emissions in a preferred combustor are in the range of 30 to 40 for fuel flux's of 4 to 40 (lb/hr). Those values pertain to a preferred combustor operating in the temperature range of 2500 to 3000° F., having an annular cross section, a flow path along the axis of the turbine of about 20 to 30 centimeters, and a cross sectional diameter of the annular cross section of about 20 to 30 centimeters.

Both primary zone combustion air and dilution zone combustion air are channeled through turbine 320 and then into recuperator 340 which transfers thermal energy from the hot exhaust gases that flow through recuperator 340 to air in passages 420, 430. The use of recuperator 340 in the gas turbine cycle may significantly increase efficiency. In recuperator 340, both primary zone passage 420 and dilution zone passage 430 are separated flow passages, and thereby maintain separate flow of primary zone air and dilution zone air. Consequently, the separate passages in recuperator 340 enable control of AFR in primary zone 410.

Air exits recuperator 340 and flows to combustor 360. In or near combustor 360, the primary combustion zone air is mixed with metered fuel in a premix chamber or injector 460. The metered fuel is provided by a variable controlled fuel valve 480 that adjusts the flow rate of inlet fuel 490. The metered fuel mixes with primary zone air and is burned upon entering combustor 360. Combustor 360 is designed to allow sufficient time for complete combustion of the air/fuel mixture in primary zone 440, prior to entering or flowing into dilution zone 450. In dilution zone 450, residual combustion products are mixed with the dilution air, and then pass through turbine 320. In dilution zone 450, air that is otherwise restricted from primary zone 440 by air valve 470 is present. This dilution air is not only compressed, but also has thermal energy that is obtained during heat transfer within recuperator 340. Therefore, the energy of the dilution air is enhanced and is used in driving turbine 320. While not shown, dilution zone 360 may include an air distributor to evenly distribute air entering from dilution flow channel 430 in order to promote mixing of dilution air with hot air gas mixture arriving from the primary zone. Such a structure could form a shower head type of distribution or any other multiple nozzle array along the walls or within the body space of dilution zone 360.

Turbine 320 rotates to produce mechanical energy. Turbine 320 may be coupled to shaft 530. Turbine 320 also may be coupled to compressor 370 and/or starter 500. Controller 350 may also provide power to load 510.

Turbine 320 exhausts hot turbine gases to recuperator 340 where excess thermal energy is transferred from hotter exhaust gases on hot side 412 to cooler air on cool side 410. After passage through hot side 412, the exhaust gases may be vented to atmosphere, may be coupled through catalytic converter 550, or may be coupled to a downstream heat exchange, such as a building heating system.

For a given combustor geometry and gas inlet temperature, a balanced minimization of the emissions by-products may be achieved for a single air-to-fuel ratio (AFR) value. In this situation, the AFR value must be maintained constant over the operating range so that the balanced minimization of byproducts is achieved. According to one embodiment of the present invention, the AFR value is kept nearly constant over the operating range of gas turbine 320 by actively controlling the flux of primary zone combustion air.

In the preferred embodiment, a balanced minimization of emissions over the operating power range of the turbogenerator system is achieved because air valve 470 is regulated to reproduce a substantially constant AFR set-point characterized by a balanced minimization of emissions and because air valve 470 may force more air to dilution zone 450, creating a means to control of AFR. Thus, maintaining two separate air passages through the recuperator 340 and combustor 360 results in a balanced minimization of undesirable hydrocarbon, CO and NOx emissions.

Disposing air valve 470 on the intake side of recuperator 340 exposes the valve to lower temperatures than if located at the outlet end of recuperator 340. Lower operating temperatures result in a less expensive and more reliable valve.

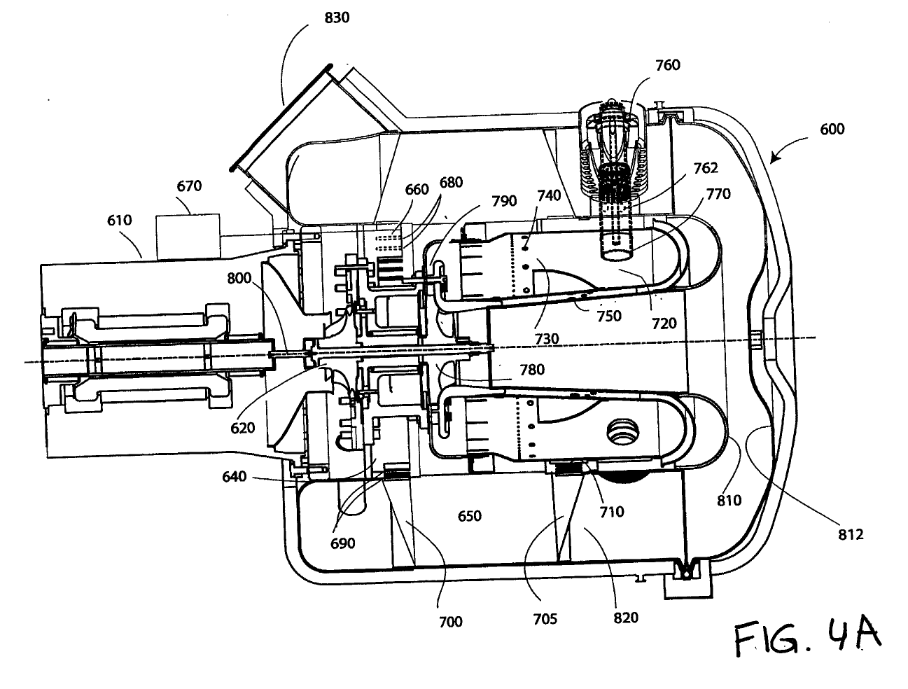

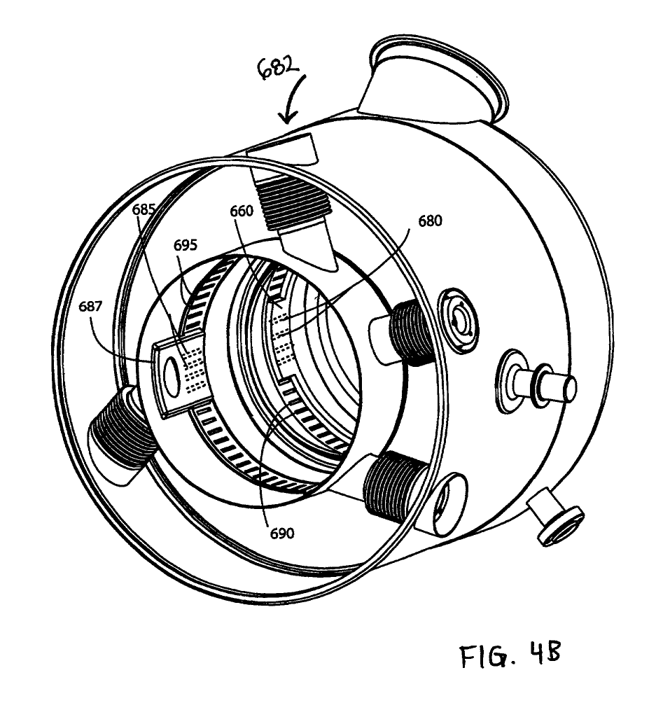

Referring now to FIG. 4A, it illustrates gas turbine engine 600 and generator 610. Generator 610 is coupled to compressor 620. Diffuser 630 reduces compressor exit loss, converting a portion of the air stream's dynamic head at the compressor exit to static pressure rise in the plenum, and it is disposed at an inlet of compressor 620. At the exit of compressor 620, plenum 640 split into two passages one of which opens to the dilution zone passage in recuperator core 650. The other of the two passages formed by plenum 640 contains sliding valve 660 and connects across sliding valve 660 to the primary zone passage in recuperator core 650.

The aperture in sliding valve 660 is controlled by actuator 670. The aperture in valve 660 opens to primary passage 680. Primary passage 680 (schematically illustrated by a dashed line) is divided inside recuperator core 650 into a plurality of common end point paths through each of which gas travels from the compressor side to the combustor side of the recuperator core 650. Likewise, dilution passage 690 in recuperator core 650 is similarly split into a plurality of common end point paths. Each path in recuperator core 650 defines a different physical path for gas flow in recuperator core 650, and the paths maintain the primary passage 680 separate from dilution passage 690. Both primary passage 680 and dilution passage 690 extend from the compressor or cold side 700 of recuperator core 650 to the combustor or hot side 705 of recuperator core 650. The combustor or hot side 705 of recuperator core 650 is adjacent to the position, along an axis defined by the common shaft 800, of the center of combustor 710.

Volume proximate to injector 760 discharges within combustor 710 defines primary zone 720. Dilution zone 730 is upstream of turbine inlet 790 and normally downstream of primary zone 720. In dilution zone 730, dilution holes 740 are disposed around a surface of combustor 710 for admitting dilution air.

Referring to FIG. 4B, it illustrates power head 682 within which discharge 685 of a passage originating with intake 680 by duct 687 is disposed. Primary zone 720 is coupled to recuperator core 650 at discharge 686.

Referring again to FIG. 4A, premix injector 760 is disposed at the intake of primary zone 720. Premix injector includes diffuser holes 762 and injector tube 770.

Dilution zone 730 communicates with turbine nozzle 790, which allows hot gas to flow into turbine 780. Shaft 800 is rotatably supported within turbine 780. Diffuser dome 810 and housing 812 define a passage from an exhaust side of turbine 780 to a hot side of recuperator core 650. Preferably, dilution zone 730 is disposed downstream from primary zone 720.

During operation, room pressure air is preferably drawn through passages in generator 610 by compressor 620 and passes through diffuser 630. At that point, the air in plenum 640 flows to recuperator core 650. Actuator 670 controls the size of the aperture in sliding valve 660, which regulates the flux of air that passes air through to primary zone 720 of combustor 710. Both the primary zone air and the dilution zone air pass through cold side of recuperator core 650 and exit above the center of combustor 710.

Fuel and air in a desired ration mix and combust in primary zone 720. Dilution zone air is forced through front dilution holes 740 and also travels around the back of combustor 710 and through secondary dilution holes 750. Primary zone air travels through primary zone 720 and enters premix injector 760. Primary zone air then mixes with fuel which air is provided via diffuser holes 762. Mixing is completed within injector tube 770. Ignition and combustion preferably occur in primary zone 720. The fuel and air are burned in primary zone 720, and then enter dilution zone 730. In dilution zone 730, primary zone combustion products mix with the dilution air, and lower the temperature of the combined mixture entering the turbine nozzle 790 and passing through turbine 780. The hot gases expand across turbine 780, and thereby create mechanical forces which rotate shaft 800. Turbine exhaust gases flow between diffuser dome 810 and housing 812 to hot side 820 of recuperator core 650. The thermal energy from the hot exhaust gases in recuperator core 650 transfers to the colder inlet air. The hot exhaust gases exhaust from recuperator core 650 at exhaust exit 820 and exhaust from the turbogenerator at exhaust 830.

The low emission turbine engine system provides a cycle which maximizes the efficiency by maintaining one or more predetermined AFR values, one for either each fuel flow or fuel flow range or power level or power level range. The AFRs and the ranges at which they are applied are AFRs determined to result in a balanced minimization of detrimental hydrocarbon, CO and NOx emission byproducts.

Moreover, the use and maintenance of AFRs over power level and fuel flow described above can be implemented in single or multiple air compression devices, and in single or multiple turbine stage devices. A multiple air compression device is one in which multiple compressors in series are used to achieve a desired air flux and control over air flux.

Furthermore, the combustor may contain multiple zones with structure for inserting dilution air into each zone. Each zone of the combustor may be distinguished from an adjacent zone by a neck wherein the inner diameter or dimensions of the combustor are reduced relative to the diameter or dimension in each zone. The zones in the combustor may merely be different regions of the combustor with no neck or other structure except for the locations of points of entry of air or air and fuel.

Obviously, numerous modifications and variations of the present invention are possible in light of the above teachings. It is therefore to be understood that within the scope of the appended claims, the invention may be practiced otherwise than as specifically described herein.

1. A turbogenerator system, comprising:
a plenum that bifurcates into a primary passage and a dilution passage, said primary passage defines separate air flow from said dilution passage;
a combustor including a primary zone and a dilution zone;
an air valve disposed along said primary passage between the bifurcation in said plenum and a primary zone of said combustor such that control of said air valve can regulate air flow in said primary passage;
said primary zone of said combustor coupled to said primary passage; and
said dilution zone of said combustor coupled to said dilution passage.

2. The turbogenerator of claim 1 further comprising a recuperator through which pass said primary passage and said dilution passage.

3. The turbogenerator of claim 1 further comprising a control means for controlling flux of air in said air valve to maintain an AFR value.

4. The turbogenerator of claim 1 further comprising a controller for controlling an aperture in said air valve to maintain an AFR value.

5. The turbogenerator of claim 4, wherein said AFR value is substantially constant over a power or fuel flow range of said turbogenerator.

6. The turbogenerator of claim 1, wherein said air valve is located at a compressor side of said recuperator.

7. The turbogenerator of claim 3, further comprising a controller capable of adjusting said air valve such that a quantity of air flowing through said air valve maintains an AFR in said primary combustion zone, said controller coupled to said air valve.

8. The turbogenerator of claim 1, further comprising a compressor whose exit passage defines the bifurcation in said plenum.

9. The turbogenerator of claim 1 further comprising a premix fuel injector coupled to an intake side of said primary zone, said premix fuel injector capable of supplying fuel to said primary zone.

10. A method of using a turbogenerator system, comprising the steps of:
separating air flow in a plenum into a primary passage and a dilution passage, wherein said primary passage defines separate air flow from said dilution passage;
controlling flux of air flow along the primary passage from said plenum to a primary zone of a combustor with an air valve; and
allowing air to flow along the dilution passage into a dilution zone of said combustor.

11. The method of claim 10 further comprising extending said primary passage and said dilution passage through a recuperator.

12. The method of claim 10 further comprising controlling flux of air in said air valve to maintain an AFR value.

13. The method of claim 10 further comprising controlling an aperture in said air valve to an aperture value.

14. The method of claim 13 wherein said aperture value maintains an AFR value.

15. The method of claim 13 wherein said AFR value is substantially constant over a substantial power or fuel flow range of said turbogenerator.

16. The method of claim 10 wherein said air valve is located at a compressor side of said recuperator.

17. The method of claim 10 further comprising adjusting said air valve such that a quantity of air flowing through said air valve maintains an AFR in said primary combustion zone.

18. The method of claim 10 further comprising compressing air delivered to said plenum.

19. The method of claim 10 further comprising heating air that passes from said plenum to said combustor using heat gases exhausted from said combustor.

20. A computer program product comprising a memory medium programmed to instruct a turbogenerator to control an AFR value delivered to a primary combustion zone of a combustor of said turbogenerator.

21. The product of claim 19 further comprising data stored in said medium defining at least one of (1) at least one AFR values and (2) at least one set of control values for controlling air and fuel flow that provides minimized incomplete emission products when operating said turbogenerator.

22. The product of claim 20 further comprising an ability to obtain and utilize feedback signals from transducers including flame-out, emissions, and temperature.

23. A combustor portion of a generator system, comprising:
a combustor including a primary zone and a dilution zone;
means for providing air and fuel in an AFR to a primary zone entrance into said combustor, said primary zone entrance connecting to said primary zone; and
means for providing additional air to a dilution zone entrance into said combustor, said dilution zone entrance connecting to said dilution zone.

24. A method for using a turbogenerator system comprising the steps of:
flowing air and fuel into a primary combustion zone of a combustor to maintain an AFR; and
flowing additional air into a dilution zone of said combustor.

25. The method of claim 24 wherein said dilution region of said combustor is closer to a turbine of said turbogenerator than said primary combustion zone.

26. The method of claim 24, wherein the air flowing into both the primary combustion zone and the dilution zone is compressed air, and further comprising compressing the air flowing into the primary combustion zone and the air flowing into the dilution zone in the same compressor.
